(19) United States
(12) Patent Application Publication
(10) Pub. No.: US 2006/0103833 A1
(43) Pub. Date: May 18, 2006

(54) Aligning apparatus and its control method, and exposure apparatus

(75) Inventor: Atsushi Kimura, Tochigi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/330,182

(22) Filed: Jan. 12, 2006

Related U.S. Application Data
(62) Division of application No. 10/911,729, filed on Aug. 5, 2004.

(30) Foreign Application Priority Data
Aug. 13, 2003 (JP) 2003-292922

(51) Int. Cl. G03B 27/58

(52) U.S. Cl. 355/72; 355/75

(57) ABSTRACT

An aligning apparatus having a stage movable on a stage base, a table, which is provided on the stage and which is movable while holding an object to be aligned, an actuator to perform alignment of the stage, an actuator to perform alignment of the table, an electromagnetic coupling, which is provided between the stage and the table and which generates a thrust force to be supplied to the table, a controller to perform servo control on the table, and a magnetic flux control system to perform magnetic flux control on the electromagnetic coupling. A time function of a table acceleration command value is a differential continuous value, and the square root of the time function is also a differential continuous value.

This application is a divisional application of copending patent application Ser. No. 10/911,729, filed Aug. 5, 2004.

### FIELD OF THE INVENTION

The present invention relates to a technique, applied to, e.g., an exposure apparatus to form a predetermined pattern on a plate shaped substrate such as a semiconductor wafer or a liquid crystal panel, of aligning a wafer stage, a reticle (mask) stage, or the like.

### BACKGROUND OF THE INVENTION

An aligning apparatus as a stage apparatus, using thrust generation means, such as an electromagnetic coupling, employed in an exposure apparatus, or the like, is known by, e.g., Japanese Patent Application Laid Open No. 2000-106344. The apparatus has a stage movable on a stage base, a table which is provided on the stage and which is movable while holding a subject of alignment, an actuator for aligning of the stage, an actuator for aligning of the table, and an electromagnetic coupling, which is provided between the stage and the table and which generates a thrust force to be provided to the table.

In this apparatus, an aligning command value supplied to a control system to perform table alignment servo control is calculated by setting a time function of an acceleration command value from parameters such as maximum acceleration, final attainable speed and a moving amount, and then performing second-order integration on the time function. FIG. 2 shows temporal transition of the above time function. As shown in FIG. 2, the time function is set to linearly change to form a trapezoidal shape. In FIG. 2, the horizontal axis indicates time, and the vertical axis, acceleration. The expression of the time function is, assuming that t means time,

$$\begin{matrix}0 & … & ( t < t0 ) \\ \frac{A}{t1 - t0} ( t - tO ) & … & ( to < t < t1 ) \\ A & … & ( t1 < t < t2 ) \\ - \frac{A}{t3 - t2} ( t - t3 ) & … & ( t2 < t < t3 ) \\ 0 & … & ( t3 < t < t4 ) \\ - \frac{A}{t5 - t4} ( t - t4 ) & … & ( t4 < t < t5 ) \\ - A & & \\ \frac{A}{t7 - t6} ( t - t7 ) & … & ( t6 < t < t7 ) \\ 0 & … & ( t7 < t ) .\end{matrix}$$

On the other hand, the thrust force supplied from the electromagnetic couple is proportional to the table acceleration command value. Accordingly, as a magnetic flux command value to the electromagnetic couplings, an input value is generally obtained by multiplying the square root of the time function of the table acceleration command value by some constant.

However, as the time function of the acceleration command value as shown in FIG. 2 is a differential discontinuous value, it has high vibration energy in a wide frequency area. In a case when the table is moved at this acceleration, it is vibrated in various frequency areas, thus vibration control performance in this operation is not excellent. Further, a heavy load is imposed on the servo control system which performs vibration control.

As a countermeasure against the above problem, the table acceleration command value may be obtained as a differential continuous value. However, if the magnetic flux command value for the electromagnetic coupling is a differential discontinuous value, the output from the electromagnetic coupling may not correspond to the acceleration command value. As a result, the error between the thrust force generated by the electromagnetic coupling and the acceleration command value is compensated for by the table driving actuator. This increases the load on the actuator, and further, lowers the vibration control performance of the aligning apparatus.

### SUMMARY OF THE INVENTION

The present invention has its object to provide a technique of driving, without imposing an excessive load on an actuator.

To solve the above problem, the present invention provides an aligning apparatus that comprises a stage which alignably is provided on a base, a table which holds an object to be aligned and is alignably provided with respect to the stage, thrust generation means for generating a thrust force to be supplied to the table, table control means for controlling to align the table, and thrust control means for controlling the thrust generation means, wherein a time function of a table control command value in the table control means and a time function of a thrust generation means control command value in the thrust control means are differential continuous values.

Further, the present invention provides a control method for an aligning apparatus that has a stage which is alignably provided on a base, a table which holds an object to be aligned and is alignably provided with respect to the stage, and thrust generation means for generating a thrust force to be supplied to the table, wherein a time function of a table control command value in table aligning control and a time function of a thrust generation means control command value in control by the thrust generation means are differential continuous values.

Further, it is preferable that the time function of the thrust generation means control command value is a square root of the time function of the table control command value.

Further, it is preferable that, assuming that time is t and some continuous function is f(t) in divided time sections, and constants n and k unique to each section are used, k·{f(t)}ⁿ holds as the time function of the table control command value.

Further, it is preferable that assuming that time is t, time at which transition of the time function starts is t0, arbitrary points on a time axis are t1 to t7, and t0<t1<t2 . . . <t7 holds, the time function of the table control command value is expressed as

$$\begin{matrix}0 & … & ( t < t0 ) \\ \frac{A}{4} {\{ 1 - cos \frac{π}{t1 - t0} ( t - t0 ) \}}^{2} & … & ( t0 < t < t1 ) \\ A & … & ( t1 < t < t2 ) \\ \frac{A}{4} {\{ 1 + cos \frac{π}{t3 - t2} ( t - t2 ) \}}^{2} & … & ( t2 < t < t3 ) \\ 0 & … & ( t3 < t < t4 ) \\ - \frac{A}{4} {\{ 1 - cos \frac{π}{t5 - t4} ( t - t4 ) \}}^{2} & … & ( t4 < t < t5 ) \\ - A & … & ( t5 < t < t6 ) \\ - \frac{A}{4} {\{ 1 + cos \frac{π}{t7 - t6} ( t - t6 ) \}}^{2} & … & ( t6 < t < t7 ) \\ 0 & … & ( t7 < t )\end{matrix}$$

Further, it is preferable that the thrust generation means is an electromagnetic coupling provided between the stage and the table, and wherein the table control means performs servo control on the table, further wherein the thrust control means performs magnetic flux control on the electromagnetic coupling.

Further, the aligning apparatus according to the present invention is applicable to an exposure apparatus for aligning a substrate, an original or both.

According to the present invention, the load on the actuator can be reduced. Further, the vibration control performance of the aligning apparatus can be improved.

Particularly, if the magnetic flux command value for the electromagnetic coupling as the thrust generation means is a differential continuous value, the error between the thrust force generated by the electromagnetic coupling and the table acceleration command value is reduced, thus the load on the table driving actuator can be reduced.

As described above, according to the present invention, the load on the actuator can be reduced. Further, the vibration control performance of the aligning apparatus can be improved.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such an example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram showing constituent elements of an aligning apparatus used in an exposure apparatus or the like;

FIG. 2 is a line graph showing the time function of the conventional table acceleration command value;

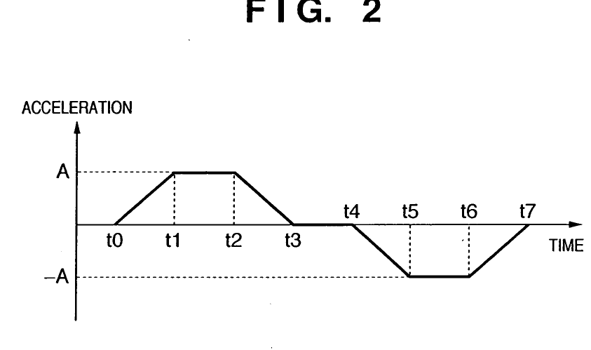

FIG. 3 is a block diagram showing a servo control system of a table including electromagnetic couplings and a flux control system;

FIGS. 4A to 4C are line graphs showing respective time functions of a position command value, an acceleration command value and the square root of the acceleration command value provided to the table of the embodiment;

FIG. 5 is a cross-sectional diagram showing an example of an exposure apparatus to which the embodiment is applied as a wafer stage; and

FIG. 6 is a flowchart showing a device manufacturing process.

### DETAILED DESCRIPTION OF THE PREFERRED EMBODIMENTS

Preferred embodiments of the present invention will now be described in detail in accordance with the accompanying drawings.

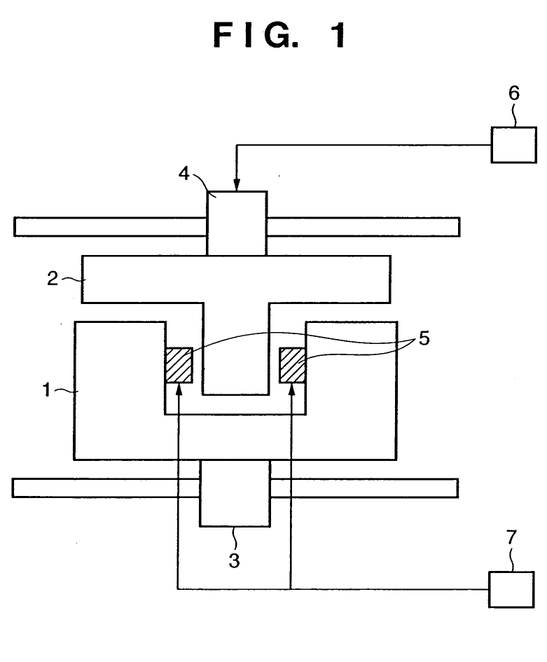

FIG. 1 schematically shows constituent elements of the aligning apparatus of the above-described JPA 2000-106344, used in an exposure apparatus, or the like. The aligning apparatus has a stage 1 movable on a stage base, a table 2 which is provided on the stage 1 and which is movable while holding an object of alignment, an actuator 3 to perform alignment of the stage 1, an actuator 4 to perform alignment of the table 2, an electromagnetic coupling 5, which is provided between the stage 1 and the table 2 and which generates a thrust force to be supplied to the table 2, a controller 6 to perform servo control on the stage 1 and the table 2, and a magnetic flux control system 7 to perform magnetic flux control on the electromagnetic coupling 5.

The stage 1 is supplied with the thrust force for driving by the actuator 3. Further, a controller to control the stage 1 (not shown) performs servo control based on position information from a position detection device (not shown) in the stage 1. In this manner, the stage 1 is freely moved in rightward and leftward directions to the paper surface, and thus, is aligned.

The table 2, connected to the stage 1 via the electromagnetic coupling 5, is supplied with the thrust force from the electromagnetic coupling 5. Further, the position of the table 2 with respect to the stage 1 is controlled by the actuator 4, the controller 6 and a position detection device (not shown) of the table 2.

The magnetic flux control system 7 controls the magnetic flux of the electromagnetic coupling 5, and the magnetic flux is controlled to follow a magnetic flux command value. Such control is explained in detail hereafter.

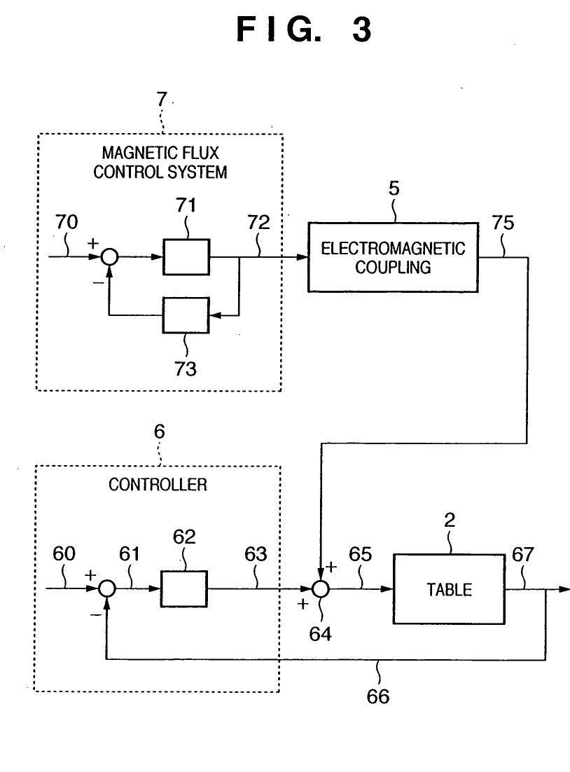

FIG. 3 is a block diagram of a servo control system of the table 2 including the electromagnetic coupling 5, showing the magnetic flux control system 7 within a dot-line frame, the electromagnetic coupling 5, the controller 6 within a dot-line frame, and the table 2.

The controller 6 receives a table 2 position command value information (signal) 60, and subtracts a feedback information (signal) 66 on actual table 2 position information from the value of the position command value information 60, and thereby generates difference information (signal) 61. A control computation unit 62 receives the value of the difference information 61, and calculates control computation information (signal) 63 as a control computation output.

The magnetic flux control system 7 receives magnetic flux command value information (signal) 70 for the electromagnetic coupling 5. Numeral 71 denotes a magnetic flux controller for the electromagnetic coupling 5; and 73, a magnetic flux measuring unit for the electromagnetic coupling 5. A feedback system to control the magnetic flux of the electromagnetic coupling 5 is constructed with the magnetic flux controller 71 and the magnetic flux measuring unit 73. The magnetic flux controller 71 outputs magnetic flux command information (signal) 72 to the electromagnetic coupling 5 as thrust generation means. Numeral 75 denotes thrust information indicating the thrust force supplied via the electromagnetic coupling 5 to the table 2 having a value proportional to the square of the value of the magnetic flux command information 72.

The thrust information 75 is added by an adder 64 to the control computation information 63 outputted from the control computation unit 62, as driving command value information (signal) 65 to the actuator 4. The table 2 is moved in accordance with the driving command value information 65. The output from a position measuring unit 67, which measures the position of the table 2, becomes table 2 actual position information 66.

In the aligning apparatus and its control method as the embodiment of the present invention, in the construction of the aligning apparatus in FIG. 1 and the control block in FIG. 3, the time function of the acceleration command value for the stage 1 and the table 2 is a differential continuous value and the square root of the function is a differential continuous value.

More particularly, the time function of the position control command value supplied to the servo control system of the table 2 is obtained from the parameters such as the maximum acceleration, the final attainable speed and the moving distance of the table 2, and the time function is subjected to second-order integration. The time function is set such that the following expression 4 is held. That is, assuming that t is time, the acceleration of the table 2 starts from time t0 as time at which the transition of the time function starts, and t1 to t7 are arbitrary time points on the time axis, and further assuming that t0<t1<t2< . . . <t7 holds,

$$\begin{matrix}0 & … & ( t < t0 ) \\ \frac{A}{4} {\{ 1 - cos \frac{π}{t1 - t0} ( t - t0 ) \}}^{2} & … & ( t0 < t < t1 ) \\ A & … & ( t1 < t < t2 ) \\ \frac{A}{4} {\{ 1 + cos \frac{π}{t3 - t2} ( t - t2 ) \}}^{2} & … & ( t2 < t < t3 ) \\ 0 & … & ( t3 < t < t4 ) \\ - \frac{A}{4} {\{ 1 - cos \frac{π}{t5 - t4} ( t - t4 ) \}}^{2} & … & ( t4 < t < t5 ) \\ - A & … & ( t5 < t < t6 ) \\ - \frac{A}{4} {\{ 1 + cos \frac{π}{t7 - t6} ( t - t6 ) \}}^{2} & … & ( t6 < t < t7 ) \\ 0 & … & ( t7 < t )\end{matrix} \qquad Expression 4$$

Then, the above time t0 to t7 and A are determined from the parameters such as the maximum acceleration, the final attainable speed and the moving distance of the table 2.

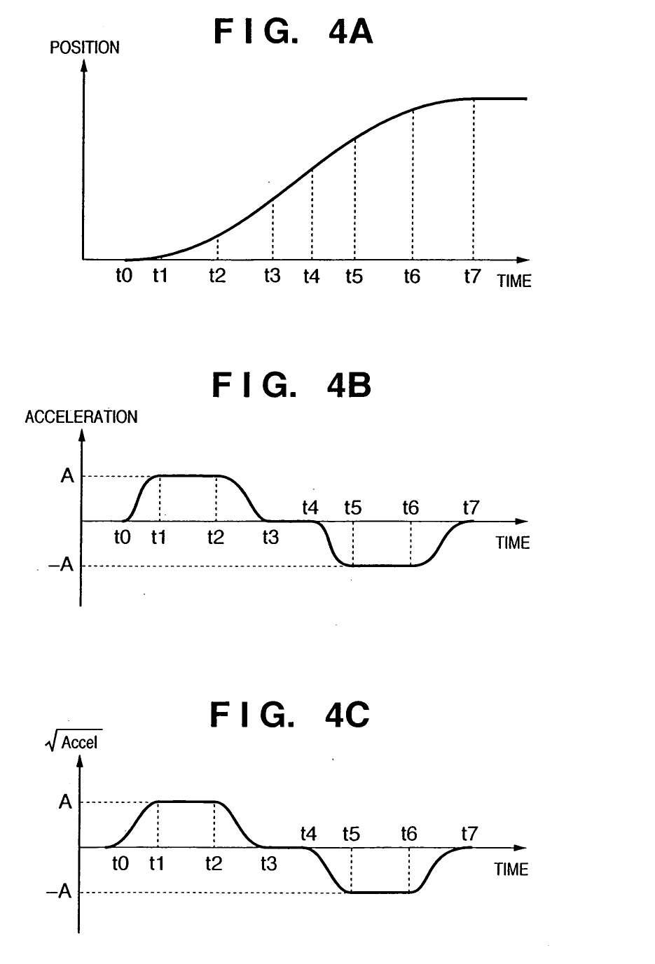

FIG. 4B shows a graph of the above expression 4, in which the vertical axis indicates the acceleration and the horizontal axis, time. FIG. 4A shows the position command value of the table 2 generated by performing second-order integration on the expression 4. As understood from the graph shown in FIG. 4B and the expression 4, the time function of the table 2 acceleration command value in the expression 4 is a differential continuous value as −∞<t<∞ holds.

By setting the time function of the acceleration command value as a differential continuous value as in the above expression 4, the vibration energy supplied to the table 2 upon driving is reduced, thus the oscillation of the table 2 can be prevented. Further, the load on the control system can be reduced.

Further, the magnetic flux command value supplied to the magnetic flux control system of the electromagnetic coupling 5 is proportional to the square root of the time function in the expression 4. That is, the square root of the expression 4 is as follows.

$$\begin{matrix}0 & … & ( t < t0 ) \\ \frac{\sqrt{A}}{2} {\{ 1 - cos \frac{π}{t1 - t0} ( t - t0 ) \}}^{2} & … & ( t0 < t < t1 ) \\ \sqrt{A} & … & ( t1 < t < t2 ) \\ \frac{\sqrt{A}}{2} {\{ 1 + cos \frac{π}{t3 - t2} ( t - t2 ) \}}^{2} & … & ( t2 < t < t3 ) \\ 0 & … & ( t3 < t < t4 ) \\ - \frac{\sqrt{A}}{2} {\{ 1 - cos \frac{π}{t5 - t4} ( t - t4 ) \}}^{2} & … & ( t4 < t < t5 ) \\ - \sqrt{A} & … & ( t5 < t < t6 ) \\ - \frac{\sqrt{A}}{2} {\{ 1 + cos \frac{π}{t7 - t6} ( t - t6 ) \}}^{2} & … & ( t6 < t < t7 ) \\ 0 & … & ( t7 < t )\end{matrix} \qquad Expression 5$$

Further, FIG. 4C shows a graph of the square root of the expression 4 as expressed in the above expression 5. As understood from FIG. 4C and the expression 5, the time function of the expression 5 is a differential continuous value as −∞<t<∞ holds.

In the above expression 5, if the magnetic flux command value supplied to the electromagnetic coupling 5 is a differential continuous value, in the magnetic flux of the electromagnetic coupling 5 as the output from the magnetic flux control system 7, the compliance with the magnetic flux command value is improved. The difference between the thrust force generated by the electromagnetic coupling 5 and the acceleration command value of the table 2 is reduced, and the load on the actuator 4 is reduced.

According to the above-described embodiment, in a case wherein the acceleration command value, which is differential continuous and the square root of which is also a differential continuous value, as in the expressions 4 and 5, is supplied to the table 2, the oscillation of the table 2 can be prevented, and the load on the control system and the actuator can be reduced.

That is, as the time function of the stage and table acceleration command value is a differential continuous value, the vibration energy applied to the stage and table is reduced, thus, the load on the servo control system can be reduced.

Further, as the square root of the time function, i.e., the electromagnetic flux control value for the electromagnetic coupling is a differential continuous value, the error between the thrust force generated by the electromagnetic coupling and the table acceleration command value is reduced, and the load on the actuator is reduced.

Next, another embodiment of the present invention will be described. Assuming that t is time, the acceleration of the table 2 starts from time t0 as time at which the transition of the time function starts, and t1 to t7 are arbitrary time points on the time axis, and further assuming that t0<t1<t2< . . . <t7 holds, the time function is set as in the following expression 6.

$$\begin{matrix}0 & … & ( t < t0 ) \\ \frac{A}{16} {\{ 1 - cos \frac{π}{t1 - t0} ( t - t0 ) \}}^{4} & … & ( t0 < t < t1 ) \\ A & … & ( t1 < t < t2 ) \\ \frac{A}{4} {\{ 1 + cos \frac{π}{t3 - t2} ( t - t2 ) \}}^{2} & … & ( t2 < t < t3 ) \\ 0 & … & ( t3 < t < t4 ) \\ - \frac{A}{4} {\{ 1 - cos \frac{π}{t5 - t4} ( t - t4 ) \}}^{2} & … & ( t4 < t < t5 ) \\ - A & … & ( t5 < t < t6 ) \\ - \frac{A}{16} {\{ 1 + cos \frac{π}{t7 - t6} ( t - t6 ) \}}^{4} & … & ( t6 < t < t7 ) \\ 0 & … & ( t7 < t )\end{matrix} \qquad Expression 6$$

In a case wherein the time function is set as in the above expression 6, as the time function of the table acceleration command value and its square root become differential continuous values, the load on the servo control system and the actuator can be reduced as described above.

Further, at around the time t3, the value of the time function changes more mildly than in the expression 4, and as a result, vibration stabilization time in the table 2 after the time t3 is shorter than that in the case of the function in the expression 4. The section from the time t1 to t3, i.e., the table 2 acceleration time is longer than that in the expression 4. However, the vibration stabilization time in the table 2 from the acceleration start time t1 can be reduced by optimum setting of the parameters from t0 to t3. As a result, the table 2 aligning performance can be improved.

The aligning apparatus controlled by using a time function as described in the above embodiments can be employed in, e.g., stage control to movably hold a substrate such as a wafer or an original such as a reticle, and is applicable to an exposure apparatus which performs alignment of a substrate or original or both, and projection exposure, and other processing and measuring equipments.

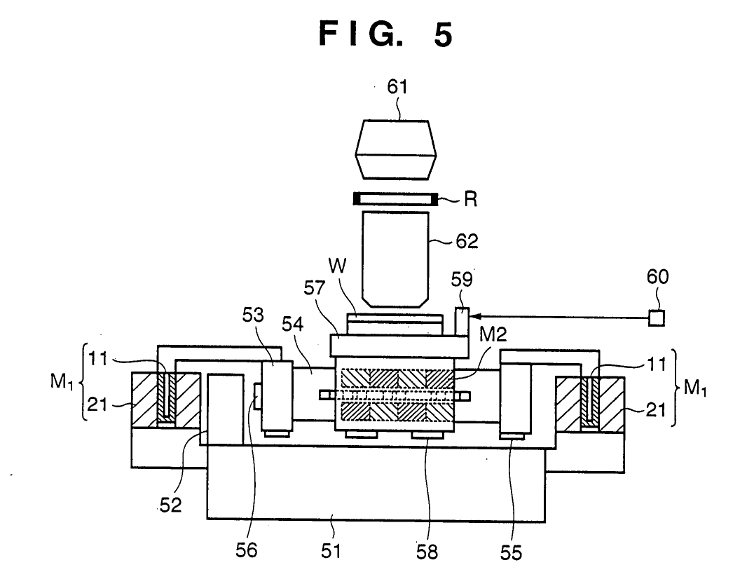

FIG. 5 shows an exposure apparatus for manufacturing a semiconductor device, using the aligning apparatus of the present invention as a wafer stage.

The exposure apparatus is utilized in manufacturing of a semiconductor device, such as a semiconductor integrated circuit or devices, on which a fine pattern is formed, such as a micro machine and a thin film magnetic head. In the apparatus, a desired pattern is formed on the substrate by emitting exposure light (this term is a generic term of visible light, ultraviolet light, EUV light, an X-ray, an electronic beam, a charged particle beam, and the like) as exposure energy from a light source 61 via a projection lens (this term is a generic term of a refractive lens, a reflecting lens, a catadioptric lens system, a charged particle lens, and the like) 62 as a projection system, on a semiconductor wafer W as a substrate via a reticle R as an original.

In the exposure apparatus, a guide 52 and a linear motor stator 21 are fixed on a base 51. The linear motor stator 21 has a polyphase magnet coil, and a linear motor movable element 11 has a permanent magnet group. The linear motor movable element 11 is connected as a movable unit 53 to a movable guide 54 as a stage, and the movable guide 54 is moved by driving of a linear motor M1 in the direction of a normal line in the paper surface. The movable unit 53 is supported with a hydrostatic bearing 55 with reference to an upper surface of the base 51 and supported with a hydrostatic bearing 56 with reference to a side surface of the guide 52.

A moving stage 57 provided over the movable guide 54 is supported with a hydrostatic bearing 58. The moving stage 57 is driven with a linear motor M2 similar to the linear motor M1, and is moved in the rightward and leftward directions to the paper surface, with reference to the movable guide 54. The movement of the moving stage 57 is measured by using a mirror 59 fixed to the moving stage 57 and an interferometer 60.

The wafer W as a substrate is held on a chuck mounted on the moving stage 57, and the pattern of the reticle R as an original is reduce-transferred in respective areas on the wafer W by step-and-repeat or step-and-scan with the light source 61 and the projection optical system 62.

Note that the present invention is also applicable to an exposure apparatus in which a circuit pattern is directly drawn on a semiconductor wafer without a mask, and resist exposure being performed.

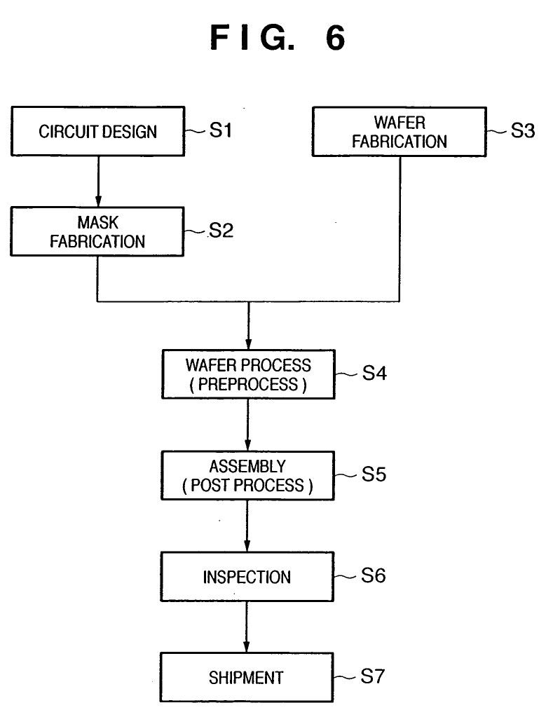

Next, a semiconductor device manufacturing process utilizing the exposure apparatus will be described. FIG. 6 is a flowchart showing an entire semiconductor device manufacturing process. At step S1 (circuit designing), a semiconductor device circuit pattern is designed. At step 2 (mask fabrication), a mask is fabricated based on the designed circuit pattern.

On the other hand, at step 3 (wafer fabrication), a wafer is fabricated by using a material such as silicon. At step 4 (wafer process), called a preprocess, an actual circuit is formed by the above exposure apparatus on the wafer by a lithography technique using the above mask and wafer. At the next step, step 5 (assembly), called a post process, a semiconductor chip is fabricated by using the wafer formed at step 4. Step 5 includes an assembly process (dicing and bonding), a packaging process (chip encapsulation), and the like. At step 6 (inspection), inspections such as a device operation check, a durability test, and the like, are performed on the semiconductor device formed at step 5. The semiconductor device is completed through these processes, and is shipped at step 7.

The wafer process at step 4 has the following steps: an oxidation step of oxidizing the surface of the wafer, a CVD step of forming an insulating film on the surface of the wafer, an electrode formation step of forming electrodes by vapor deposition on the wafer, an ion implantation step of injecting ions in the wafer, a resist processing step of coating the wafer with photo resist, an exposure step of transferring the circuit pattern onto the resist-processed wafer by the above-described exposure apparatus, a development step of developing the wafer exposed at the exposure step, an etching step of removing other portions than the resist developed at the development step, and a resist stripping step of removing the resist which is unnecessary after the completion of etching. These steps are repeated, to form a multiple layers of circuit patterns on the wafer.

The present invention is not limited to the above embodiments and various changes and modifications can be made within the spirit and scope of the present invention. Therefore, to apprise the public of the scope of the present invention, the following claims are made.

1. An aligning apparatus comprising:
a stage which alignably is provided on a base;
a table which holds an object to be aligned and is alignably provided with respect to said stage;
thrust generation means for generating a thrust force to be supplied to said table;
table control means for controlling to align said table; and
thrust control means for controlling said thrust generation means,
wherein a time function of a table control command value in said table control means and a time function of a thrust generation means control command value in said thrust control means are differential continuous values.

2. The aligning apparatus according to claim 1, wherein the time function of said thrust generation means control command value is a square root of the time function of said table control command value.

3. The aligning apparatus according to claim 1, wherein assuming that time is t and some continuous function is f(t) in divided time sections, and constants n and k unique to each section are used, k·{f(t)}ₙ holds as the time function of said table control command value.

4. (canceled)

5. The aligning apparatus according to claim 1, wherein said thrust generation means is an electromagnetic coupling provided between said stage and said table,
and wherein said table control means performs servo control on said table,
further wherein said thrust control means performs magnetic flux control on said electromagnetic coupling.

6. A control method for an aligning apparatus having:
a stage which is alignably provided on a base;
a table which holds an object to be aligned and is alignably provided with respect to said stage; and
thrust generation means for generating a thrust force to be supplied to said table,
wherein a time function of a table control command value in table aligning control and a time function of a thrust generation means control command value in control by said thrust generation means are differential continuous values.

7. An exposure apparatus in which at least one of a substrate and an original are aligned with the aligning apparatus according to claim 1.
